(19) United States
(12) Patent Application Publication
(10) Pub. No.: US 2018/0083985 A1
(43) Pub. Date: Mar. 22, 2018

(54) SYSTEMS AND METHODS FOR NETWORK SECURITY EVENT FILTERING AND TRANSLATION

(71) Applicant: ShieldX Networks, Inc., San Jose, CA (US)

(72) Inventors: Ratinder Paul Singh Ahuja, Saratoga, CA (US); Manuel Nedbal, Santa Clara, CA (US); Jitendra Bhagvant Gaitonde, Cupertino, CA (US)

(21) Appl. No.: 15/271,142

(22) Filed: Sep. 20, 2016

(51) Int. Cl. H04L 29/06

(52) U.S. Cl. CPC H04L 63/1416; H04L 63/1425; H04L 63/1433

(57) ABSTRACT

System, methods, and apparatuses enable a network security system to more efficiently process system events. For example, the disclosed approaches may be used to improve the way in which a security service processes events (e.g., network traffic, files, email messages, etc.) in order to detect various types of network security threats (e.g., network intrusion attempts, viruses, spam, and other potential network security issues). A security service generally refers to one or more microservices of a network security system which monitors and performs actions relative to input data items for purposes related to computer network security

### TECHNICAL FIELD

Embodiments relate generally to computer network security. More specifically, embodiments relate to techniques for processing event data generated by various components of a networked computer system.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The vast majority of organizations today rely on computer systems and networks for an increasingly wide variety of business operations. As the reliance on these systems networks has grown, so too has the importance of securing those computer systems and networks against internal and external security threats. However, the breadth and complexity of security threats targeting such computer systems and networks is far and wide and ever growing. To monitor and address these security threats, organizations increasingly rely on sophisticated computer network security applications and hardware such as firewalls, anti-virus tools, data loss prevention software, etc.

One aspect of many network security applications involves processing event data generated by monitored components of a computing environment. For example, a network security application may detect and log events generated by network devices, system software running on various devices, application software, among other components. The types of events generated by these and other components, for example, may correspond to instances of network messages sent and/or received by the devices, device and/or application status messages, error messages, etc.

Typically, event processing systems analyze such events by capturing and storing events in one or more logs and/or databases, and subsequently analyzing the stored events to detect occurrences of event activity of interest. However, the system resources needed to effectively capture, store, and subsequently analyze events in this manner are often strained as the number of system components increases and/or as the amount of activity within the system increases. Furthermore, the types of events generated by components of such systems often indicate granular activities of the system components (e.g., corresponding to individual network messages sent and/or received, specific error messages, etc.), whereas system administrators and other users often are more interested in a larger context of system activity corresponding to complex network security threats involving possibly several different components, performance issues resulting from multiple different interacting system activities, and so forth.

### BRIEF DESCRIPTION OF THE DRAWINGS

In the drawings:

FIG. 1 is a block diagram illustrating a security service configured to monitor traffic sent among an application and one or more servers through a routing network in accordance with the disclosed embodiments;

FIG. 2 is a block diagram illustrating a flow of application data through a stateless processing, fault-tolerant microservice environment in accordance with the disclosed embodiments;

FIG. 3 is a block diagram illustrating example components of a DPI processing microservice in accordance with the disclosed embodiments;

FIGS. 4, 5 are block diagrams illustrating an example event state table and an example event state data structure, respectively, in accordance with the disclosed embodiments;

FIG. 6 is a flow diagram illustrating an example process for filtering subevents and translating subevent activity into security events in accordance with the disclosed embodiments;

FIGS. 7A-7C illustrate block diagram examples of updating security event state data in response to occurrences of subevents in accordance with the disclosed embodiments;

FIG. 8 illustrates a computer system upon which an embodiment may be implemented.

### DETAILED DESCRIPTION

In the following description, for the purposes of explanation, numerous specific details are set forth in order to provide a thorough understanding embodiments of the present invention. It will be apparent, however, that embodiments of the present invention may be practiced without these specific details. In other instances, well-known structures and devices are shown in block diagram form in order to avoid unnecessarily obscuring embodiments of the present invention.

References in the specification to “one embodiment,” “an embodiment,” “an example embodiment,” etc., indicate that the embodiment described may include a particular feature, structure, or characteristic, but every embodiment need not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments are described herein according to the following outline:

1.0. General Overview

2.0. Operating Environment
2.1. System Overview
2.2. Event Processing Microservices

3.0. Functional Overview
3.1. Event Processing Overview
3.2. Security Event Filtering and Translation

4.0. Example Embodiments

5.0. Implementation Mechanism—Hardware Overview

6.0. Extensions and Alternatives

### 1.0. General Overview

Modern data centers and other computing environments can include anywhere from a few computer systems to thousands of systems configured to process data, service requests from remote clients and other applications, and perform numerous other computational tasks. The large number of interworking systems, applications, etc., make such computing environments susceptible to a wide variety of network security issues. A number of network security tools are available to protect such systems and the computer networks interconnecting these systems, and many of these tools comprise a monolithic set of network security functions. For example, a typical network security tool might comprise a hardware unit including firewall services, routing services, virtual private network (VPN) services, etc.

The type of network security tool described above is useful for providing a variety of network security functions as a single unit. However, efficiently scaling these types of network security tools is often challenging. For example, if a particular computer environment might benefit from increased firewall resources, a system administrator may install one or more additional hardware units each including firewall services in addition to a suite of other network security functions. While the addition of these new hardware units may meet the increased firewall resource needs, some of the hardware units may include unnecessary and/or underutilized resources devoted to virtual private network (VPN) services, data loss prevention (DLP) services, or other security services.

One way in which many modern computing environments scale resources more efficiently is using virtualized computing resources. A virtualized computing resource generally refers to an abstracted physical computing resource presented to an operating system and its applications by means of a hypervisor such that the virtual computing resources (compute, memory, network connectivity, storage, etc.) are configurable and may be different from those of the physical computing resource. According to one embodiment, these types of virtualized infrastructures are used to efficiently scale network security applications based on the use of “microservices,” where a microservice represents a particular type of virtualized computing resource packaged as a software container. For example, a network security platform may comprise separate microservices providing firewall resources, DLP services, VPN services, etc. In general, the use of such microservices can provide greater flexibility because the microservices can be more easily deployed and scaled in response to variable demands for various types of network security services.

The type of efficient network security application scaling described above can be achieved with the use of a security service that is configured to scale network security services using microservices. Although many of the techniques described herein are explained with reference to a microservice-based network security application, the techniques are also applicable to other types of network security systems.

### 2.0. Operating Environment

2.1. System Overview

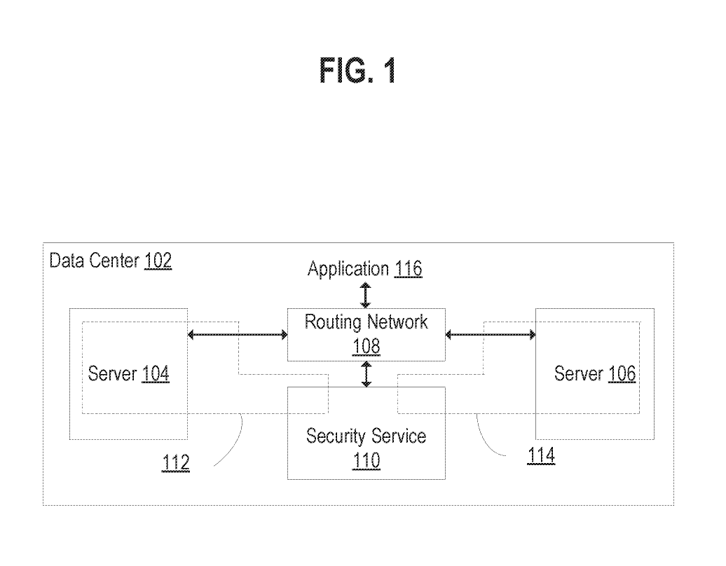

FIG. 1 is a block diagram illustrating a networked computer environment in which an embodiment may be implemented. FIG. 1 is an example embodiment that is provided for purposes of illustrating a clear example; other embodiments may use different arrangements.

The networked computer system depicted in FIG. 1 comprises one or more computing devices. These one or more computing devices comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

In one embodiment, one or more security services 110 may be configured to monitor network traffic and other data sent between an application 116 and one or more servers 104, 106 through a routing network 108. The security service 110 comprises one or more “microservices” used to monitor and perform various actions relative to data items (e.g. network traffic, files, email messages, etc.) sent to and received from one or more applications 116 and servers 104, 106. The microservices of a security service 110 do not need to be confined to one physical server such as a server 104, 106. For example, one or more microservices of the security service 110 may be executed on server 104 and other microservices of the security service 110 are executed on server 106. In some embodiments, the security service 110 is executed on a different server from one or more servers for which the security service is responsible for monitoring and protecting.

In an embodiment, a routing network 108 provides connectivity among servers 104, 106, security service 110, and application 116. In some embodiments, routing network 108 is partially configured responsive to hypervisor configuration of servers 104 and 106. In some embodiments, a routing network 108 is partially or entirely configured responsive to hypervisor configuration of servers 104 and/or 106.

In one embodiment, by virtue of routing information included in channel data encapsulation packets, data traveling between an application 116 and server 104 and/or server 106 is routed to the correct server, and is kept separate from data traveling between the application 116 and the other server. Accordingly, what is essentially a private network 112 may be created between the server running security service 110 and server 104. Similarly, what is essentially a private network 114 may be created between the server running security service 110 and server 106.

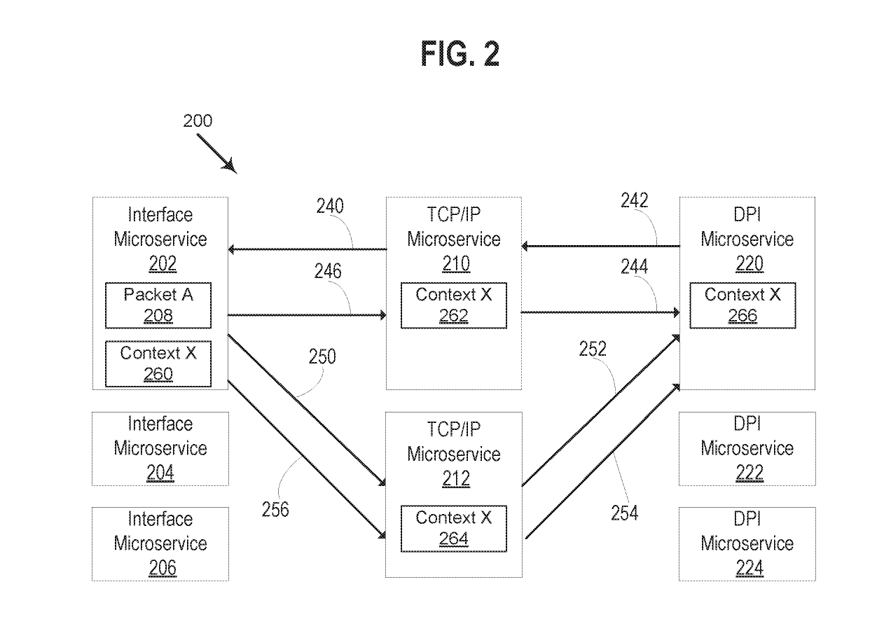

FIG. 2 is a block diagram illustrating a flow of application data through a stateless processing, fault-tolerant microservice environment in accordance with disclosed embodiments. As illustrated, security system 200 includes interface microservices 202, 204, and 206, TCP/IP microservices 210, 212, and 214, and DPI microservices 220, 222, and 224. Other examples include a different number of microservices and/or a different number of microservice types. In the example of FIG. 2, an interface microservice 202 receives packet A 208, and generates a context X 260.

One benefit of the security system illustrated in FIG. 2 is the handling of state. For example, if packets belong to a certain context X, the security system 200 may enable both TCP/IP microservices 210 and 212 to perform meaningful work on the packets. By implementing TCP/IP processing as microservices 210 and 212 with an external state structure and a context that accompanies processed data, each TCP/IP microservice, and any other microservice at every level of the security hierarchy, can be isolated from other microservices and can be scaled independently. Each microservice can access the state for any packet or reassembled packet data, thereby enabling real-time load balancing. In many cases, the context enables microservices to forego consulting service state (state associated with processing at the hierarchy level of the specific microservice), thereby reducing the demands on the global state repository.

As an example, consider the context 262 obtained by TCP/IP microservice 210 as part of packets received from interface microservice 202 as transmission 240. Context 262, when transmitted to DPI microservice 220 as part of transmission 242 along with the reassembled packet data, contains information that may enable the DPI microservice to forego or simplify processing of this reassembled data. Such information can include, for example, a field specifying a subset of regular expressions or patterns to be used for DPI processing, a number of bytes of reassembled data to be received before beginning DPI processing, specific allowed or disallowed protocols, and other information potentially avoiding a DPI state lookup.

In an embodiment, microservices of a security system 200 are stateless. For example, each of the microservices may retrieve state information from an outside source such that the microservice can process packets or content belonging to any context. Each microservice may retrieve and update service state (that state associated with the microservice processing). Additionally, each microservice may retrieve and update context state (state associated with the context relevant for all security service processing). In some embodiments, the process state and context state share a global state service. Examples of elements of context state include a level of suspicion regarding traffic from a source IP, a policy to ignore certain ports or protocols and other information used to process the packets, reassembled content, and extracted objects from communication identified with the context.

In an embodiment, multiple microservices in the same or different hierarchy of the security system may be able to process packets associated with the same context at the same time. If one security microservice fails (e.g., if a TCP microservice fails to respond to a request), another microservice can take over and process the request using the failed microservice's context.

Returning to the example of FIG. 2, the generation of context X 260 may include considering properties associated with packet A 208 (e.g., such as an n-tuple detailing routing information or information derived from routing information), and also a state lookup or a context lookup, in addition to other information. Interface microservice 202 provides packet A 208 and context X 260 to TCP/IP microservice 210 or 212 via path 240 or 250, respectively. For example, interface microservice 202 may conduct a load-balancing to select one of the TCIP/IP microservices to forward the packet A 208 and the context X 260.

In an embodiment, TCP/IP microservices 210 and 212 are stateless, but may benefit from the context X generation performed by interface microservice 202. For example, whichever of TCP/IP microservices 210 and 212 receives packet A may disassemble the packet to extract the data associated with the packet and conduct security processing on the data. TCP/IP reassembly generally consists of associating packets with flows (e.g., identified by source and destination IP and port values) and using the TCP sequence numbering to place the packets into a correct order, remove any overlap or duplication, and/or identify missing or out of order packets.

In FIG. 2, TCP/IP microservices 210 or 212 forwards the extracted data and/or the data resulting from the security processing to DPI microservice 220 via paths 242 or 252, respectively. Along with the transmitted data, TCP/IP microservice 210 or 212 forwards context X 262 or 264, respectively, to a DPI microservice 220. In some embodiments, context X 260, 262, 264, and 266 are substantially identical.

In an embodiment, DPI microservice 220 is also stateless and may use the context provided by TCP/IP microservice 210 or 212 in transmission 242 or 252. DPI microservice 220 may load DPI processing state before processing the received data, but can perform some work (e.g., scheduling different DPI pattern state tables) based on the context. Transmitting the context to the DPI microservice therefore may obviate some amount of work by the DPI microservice. If TCP/IP microservice 210 fails and interface microservice 202 instead utilizes TCP/IP microservice 212, DPI microservice 220 may obtain the context from the transmission of reassembled TCP content in transmission 252.

Although FIG. 2 does not show a second packet, when a subsequent packet associated with the same context is received, interface microservice 202 may conduct a load balancing and select one of the TCP/IP microservices to forward the packet along with context X 260. In one embodiment, interface microservice 202 chooses to forward the second packet to TCP/IP microservice 212 via path 250. TCP/IP microservice 212 performs some security processing, then transmits the second packet and context X 264 to DPI microservice 220 via path 352. After performing some security processing, DPI microservice 220 responds to TCP/IP microservice 212 via path 254, and TCP/IP microservice responds to interface microservice 202 via path 256.

Summarizing the operation of an embodiment as illustrated by FIG. 2, an interface microservice transmits packets to a TCP/IP microservice along with a context that has been generated based on the contents of the packets. The transmission comprises a request to perform a security service (e.g., TCP/IP reassembly) for the packets to generate reassembled data. The TCP/IP microservice consults the received context to determine whether to obtain a context state, service state, or both, from a state repository to perform the security service. Reassembly is performed by the TCP/IP microservice, any modified state returned to the state repository and the reassembled data transmitted, along with the context, to a DPI microservice as a request to perform DPI processing.

Continuing the example illustrated by FIG. 2, the DPI microservice receives the reassembled data and context from the request to perform DPI security services transmitted by the TCP/IP microservice. The DPI microservice consults the received context to determine whether to obtain a context state, service state, or both, from a state repository to perform its security service. DPI inspection may be performed by the DPI microservice, any modified state returned to the state repository, and a response sent to the TCP/IP microservice.

2.2. Event Processing Microservices

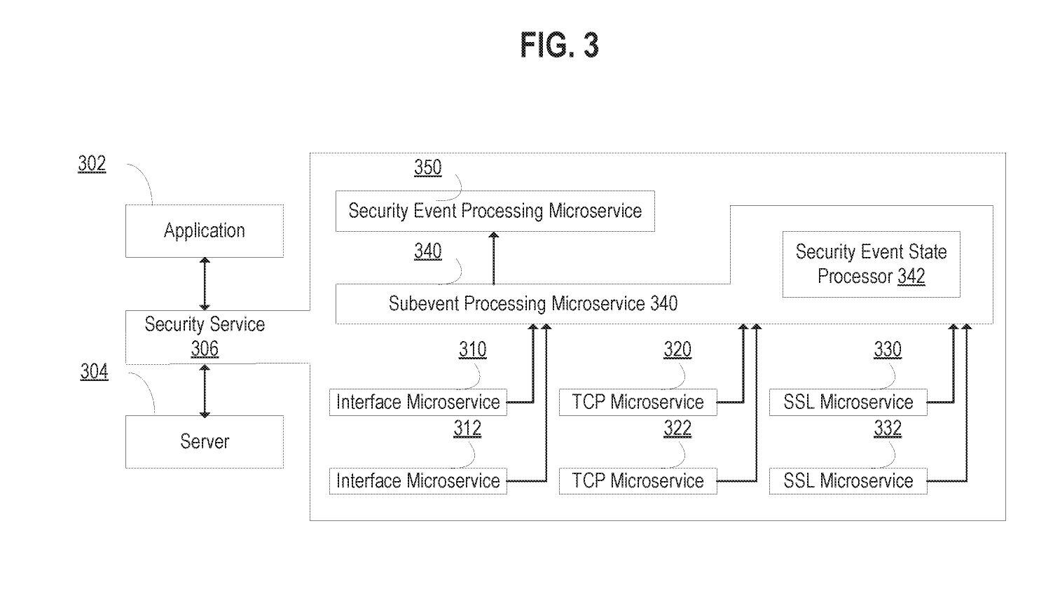

FIG. 3 is a block diagram illustrating an example of a security service comprising a plurality of microservices, including one or more microservices for processing events. In an embodiment, a security service 306 comprises a security event processing microservice 350, a subevent processing microservice 340, interface microservices 310 and 312, TCP microservices 320 and 322, and SSL microservices 330 and 332. In an embodiment, a subevent processing microservice 340 further comprises a security event state processor 342. The security service 306, for example, may correspond to the security service 306 depicted in FIG. 1, where a plurality of microservices are running within the security service 306. FIG. 3 is an example embodiment that is provided for purposes of illustrating a clear example; other embodiments may use different arrangements, including different sets of microservices within a security service 306.

According to embodiments described herein, a subevent processing microservice 340 and security event processing microservice 350 process “subevents” generated by one or more applications 302, servers 304, and/or other microservices 310-332. As used herein, a “subevent” refers generally to an action or occurrence related to one or more components of a networked computing environment. Subevents may be generated by any number of different hardware and/or software components of the computing environment. For example, subevents may be generated by network devices, user devices, servers, operating systems, user applications, etc. Examples of subevents include, but are not limited to, network status and configuration messages, a device powering on, a device powering off, a device failure, an application error, status and events within a virtual environment, etc. A subevent may correspond to an occurrence of an action itself (e.g., by detecting an incoming/outgoing network message, detecting a device failure, etc.), or a subevent may be represented by data describing a corresponding action (e.g., a log entry describing a received network message, a push notification indicating that a server reboot occurred, etc.).

In an embodiment, a subevent processing microservice 340 obtains subevents from event generating components, and detects occurrences of “security events” based on detecting defined patterns of subevents. In this context, a “security event” is an event which may be of interest to an administrator or other user associated with a monitored computing environment, and which is determined to occur based on detecting the occurrence of one or more constituent subevents. As one example, a type of security event that may be of interest to a network security administrator is a “port scan” event. At a high level, a port scan occurs when a host device (e.g., a server within a monitored computing environment) is probed for open ports. A process that performs a port scan (e.g., a process running on a different device from the device being port scanned) may do so by sending a series of client requests to a range of server port addresses on the host server. When used maliciously, a port scan may be used by a client device to identify “active” ports on the host server, thereby possibly enabling the client device to exploit known vulnerabilities in particular types of services.

In the example above of a port scan, a subevent processing microservice 340 may detect each of the client requests received by a host server as an individual subevent (e.g., in response to receiving a notification of the corresponding network messages from one or more microservices 310-332). As described in more detail in subsequent sections, a subevent processing microservice 340 may further match the detected subevents against one or more configured “security event” definitions to determine if and when the series of client requests indicates an occurrence of a “port scan” security event. Other security event definitions may define different criteria configured similarly to detect occurrences of other types of security events such as, for example, denial-of-service (DoS) attacks, brute-force login attempts, malware infections, etc.

In an embodiment, a security event state processor 342 maintains state relative to one or more security event definitions and subevents received by a subevent processing microservice 340. As indicated in the example described above, a subevent processing microservice 340 may obtain subevents from one or more applications 302, servers 304, microservices 310-332, and/or other components during operation of the system, and compare the received subevents against one or more security event definitions. To enable detecting occurrences of security event patterns, which may involve any number of comprising subevents generated by any number of different system components, a security event state processor 342 maintains state corresponding to the security event definitions to determine if and when one or more security events have occurred based on the detected subevents. For example, a security event state processor 342 may store and update, for each security event definition, one or more state tables, subevent counters, time counters, timestamps, subevent data fields, among other possible types of data.

In an embodiment, a security event processing microservice 350 performs one or more actions in response to detection of security events by a subevent processing microservice 340. Referring again to the example of a port scan described above, in response to a subevent processing microservice 340 determining that a particular pattern of subevents corresponds to an occurrence of a port scan security event, the subevent processing microservice 340 generates security event data to report the security event occurrence to a security event processing microservice 350. For example, in response to receiving an indication of a “port scan” security event, a security event processing microservice 350 may perform one or more network security actions including adding or modifying firewall security rules, running a security scan on relevant servers, or any other network security function.

In one embodiment, one or more of the microservices of the security service 306 comprises a software “container,” where a container is an isolated user space instance within a virtualization environment in which the kernel of an operating system allows for the existence of multiple isolated user-space instances. In other examples, one or more of the microservices of security service 306 is a virtual machine instance, a thread of execution, a standalone software application, or any other type of computing module. In some embodiments, event processing functionality of a security service 306 is provided by a plurality of subevent processing microservices 340 and/or security event processing microservices 350, wherein the number of microservices in operation at any given time may be scaled to meet a number of events processed by security service 306 during a particular period of time.

### 3.0. Functional Overview

Approaches, techniques, and mechanisms are disclosed that enable a network security application to more efficiently process events generated by components of a networked information technology (IT) environment. For example, the approaches described herein may be used to improve a security application's ability to process large numbers of “subevents” received from various network components, applications, and/or other microservices, and to detect occurrences of network security events (e.g., network intrusion attempts, malware infections, and/or other potential network security issues). In this context, a “subevent” refers to an action or occurrence related to one or more components of a computing environment, and a “security event” refers to a defined pattern of one or more particular subevent occurrences.

In an embodiment, a security application processes events using one or more event processing microservices, where an event processing microservice generally refers to one or more executable components of a network security system, such as the system described in Section 2.0 and depicted in FIG. 3. As illustrated in FIG. 3, for example, event processing microservices (e.g., subevent processing microservice 340 and security event processing microservice 350) may be components of a security service 306, where the event processing microservices are individual microservices among a possible plurality of other microservices configured to perform other network security related functions.

3.1. Event Processing Overview

As indicated above, some types of computer security services include functionality configured to receive, store, and subsequently analyze events generated by various components of a computing environment. However, as the number of components within a computing environment increases, and/or as the amount of activity among those components increases, the number of events to log and subsequently analyze can often increase dramatically. Furthermore, system administrators and other users often may be less interested in the occurrence of individual events generated by system components, but instead interested in occurrences of larger scale “security events” (e.g., port scans, denial-of-service (DoS) attacks, brute-force login attacks, malware infections, etc.) which may span any number of individual events and any number of different system components.

One approach to security event processing is to detect and store information related to each subevent (from all information sources) in one or more log files and/or databases, and to subsequently process the subevent data to detect occurrences of security events when resources for doing so are available. However, the resources for receiving and storing the event information may compete with resources used to subsequently process the stored subevents. Furthermore, subevent data in these systems often may be stored across different locations, across different types of storage, and represented using any number of different formats.

3.2. Network Security Event Filtering and Translation

According to embodiments described herein, a security service comprises one or more event processing microservices configured to filter and translate patterns of subevents into security events as the subevents are received, thereby essentially enabling the detection of security events in real time. In one embodiment, a security service comprises a set of security event definitions, where each security event definition is used to determine when a security event occurs. Based on the security event definitions, a subevent processing microservice receives indications of sub events from various components of a computing environment, tracks state data associated with the security event definitions, and creates security event data when defined conditions are met. By tracking state data associated with the security event definitions as subevents are received, a subevent processing microservice can create security event data when appropriate without storing and subsequently analyzing all of the subevents in various logs or databases, thereby enabling a security service to more easily scale as a number of subevents to be processed increases. Database and/or log server storage resources are further reduced by storing information related to occurrences of security events of interest, rather than storing information for every subevent comprising the security events.

As an example, consider again a port scan security event. Based on prior network activity, a system administrator may be interested in detecting occurrences of port scanning activity originating from servers having IP addresses associated with one or more particular geographic regions. To detect such occurrences, a subevent processing microservice 340 may include a security event definition indicating that a port scan security event occurs when more than N number of network messages, each requesting a different port number, are received by an internal server within M number of minutes. The security event definition may further specify that network messages matching the pattern originate from one or more particular sets of IP addresses (e.g., corresponding to IP addresses associated with particular countries from which previous attacks have originated). If the subevent processing microservice 340 detects subevents matching the defined security event definition, the microservice may generate security event data representing an occurrence of the port scan. The generated security event may contain data indicating, for example, which internal server was the target of the port scan, from which country the port scan originated, and a time associated with the security event (e.g., corresponding to a time at which the first, last, or average network message was received). As illustrated by this example, instead of creating N or more log entries corresponding to each network message received by the server and subsequently analyzing the entire log, a security service can instead create a single security event entry at the time the subevents are received and including a summary of the data found in the set of subevents comprising the security event.

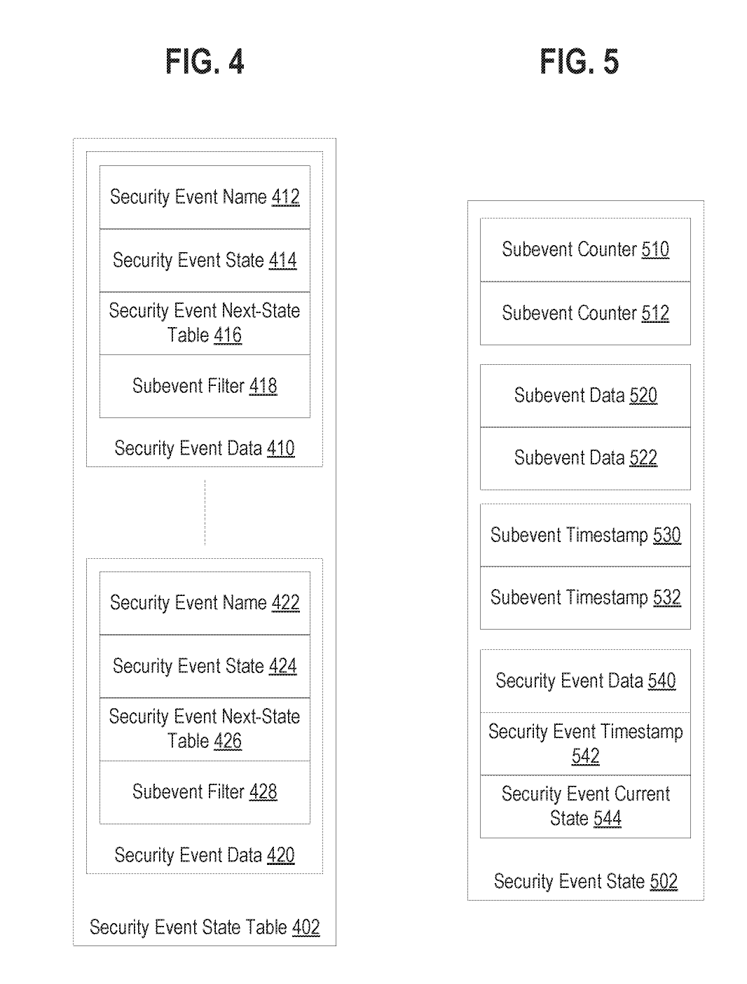

FIG. 4 depicts an example of a security event state table including a plurality of security event data entries each corresponding to a separate security event definition. In the example of FIG. 4, a security event state table 402 includes security event data entries 410-420, where each security event data entry comprises a security event name (e.g., security event names 412-422), security event state data (e.g., security event state data 414-424), a security event next-state table (e.g., security event next-state tables 416-426), and a subevent filter (e.g., subevent filters 418-420). In an embodiment, a security service 306 may store a security event state table in a database, as a file, or in any other format in local or remote storage.

In an embodiment, a security event name is a human-readable label for the security event represented by the corresponding security event data entry. For example, if a security event definition is created to detect occurrences of port scans originating from servers in North Korea, a security event name for the entry may be “Port scan from North Korea”; another example security event definition configured to detect malware attacks may be associated with the security event name “Malware attack”; yet another example security event definition configured to detect occurrences of DoS attacks originating from any location may be associated with the security event name “DoS attack from anywhere,” and so forth.

In an embodiment, a subevent filter specifies one or more criteria to determine which subevents are relevant to the associated security event definition, thereby “filtering” a total set of incoming subevents to only those subevents potentially relevant to occurrences of the associated security event. A subevent filter may be expressed as a single filter, or the filter may include a set of two or more separate filters (e.g., one filter for matching network messages of a particular type, another filter for matching network messages from one or more particular geographic locations, etc.). Referring again to an example of a port scan security event, a corresponding security event definition may include a subevent filter which indicates that subevents matching the filter include those satisfying the following criteria: 1) the subevent is a ping network message, 2) the ping network message originates from a source IP address from one or more defined sets of IP address, and 3) the destination IP address of the ping network message is one of a defined set of IP addresses (e.g., corresponding to a set of internal servers monitored by the network security service).

In an embodiment, each security event entry may include a separate set of one or more subevent filters, or two or more separate security event entries may share one or more of the same subevent filters. For example, two different security event entries may share a same subevent filter that matches network messages of a same particular type, but each of the two security event entries may include one or more different filters for finding subevents originating from different geographic locations, which arrive within different time periods, or specify other different criteria. Each subevent filter may be included as part of a security event entry, or subevent filters may be specified and stored separately such that the subevent filters can be referenced by multiple different security event entries.

In an embodiment, security event state data and security event next-state tables (e.g., security event state data 414 and security event next-state table 416) includes data comprising a state-based representation used to determine when a corresponding security event has occurred based on received subevents matching the corresponding security event filter. For example, one security event definition may define that a brute-force password attack security event occurs when N number of invalid login sub events are generated by the same internal server within a defined period of time. In this example, the corresponding security event data may include state data that increments a counter each time an invalid login subevent is generated for each server, and stores one or timestamps to determine whether N matching subevents occur in the defined period of time.

FIG. 5 depicts example elements of a security event state for a particular security event definition. For example, a security event state entry 502 may include one or more subevent counters (e.g., subevent counters 510, 512), subevent data fields (e.g., subevent data fields 520, 522), and subevent timestamp fields (e.g., subevent timestamps fields 530, 532). In an embodiment, a security event state entry 502 may further include data elements to store information related to a corresponding security event (e.g., summarizing information related to the received subevents), including security event data 540, a security event timestamp 542, and a security event current state 544. In an embodiment, a security service 306 may store security event state in a database, as a file, or in any other format in local or remote storage.

In an embodiment, as part of tracking state associated with a particular security event definition, a subevent counter (e.g., a subevent counters 510 and 512) may be configured to count one or more periods of time, count a number of occurrences of one or more particular actions, to increment or decrement a value based on the value contained in a field of subevents matching a corresponding subevent filter, etc.

In an embodiment, subevent data fields (e.g., subevent data fields 520 and 522) can be used to store various types of information related to subevents matching a corresponding filter. For example, if a particular security event definition is configured to detect occurrences of brute-force password attacks against individual servers, the associated state data may include a subevent data field to store destination IP addresses related to filtered subevents (e.g., to enable detecting subsequent subevents directed at a server having the same destination IP address). Similarly, a subevent timestamp field (e.g., subevent timestamp fields 530 and 532) may be used to store one or more timestamps associated with subevents matching an associated security event filter. For example, a subevent timestamp field may be used to store a timestamp associated with a first or most recent subevent matching an associated subevent filter (e.g., to enable determining whether one or more matching subevents are detected within a particular defined period of time).

As an example of maintaining security event state using various types of security event data elements, consider a security event definition configured to detect when a component within a computing environment is infected by a certain type of virus or malware. For example, it may be known that a certain type of malware operates by infecting a first device on a network, and then proceeds to send login attempts (e.g., using an SSH connection) to other computers within the same network domain in an attempt to spread the infection to the other computers. In this example, detecting an occurrence of a security event corresponding to this type of virus may include detecting several different types of subevents. For example, detecting an occurrence of a malware security event may include detecting an email message including an attachment known to contain the virus (e.g., because the attachment matches a hash value signature corresponding to the virus), subsequently detecting an HTTP message generated as a result of a user selecting a hyperlink contained within an email related to the virus, and further detecting a number of SSH connection attempts sent from the same computer from which the hyperlink was selected. A security event definition for detecting occurrences of a malware attack may store subevent data to record a fingerprint associated with the attachment fingerprint (e.g. a signature detected by a DPI engine), record a URL associated with a link clicked, and to record various data from network packets associated with SSH login attempts (e.g., timestamps, destination IP addresses, etc.).

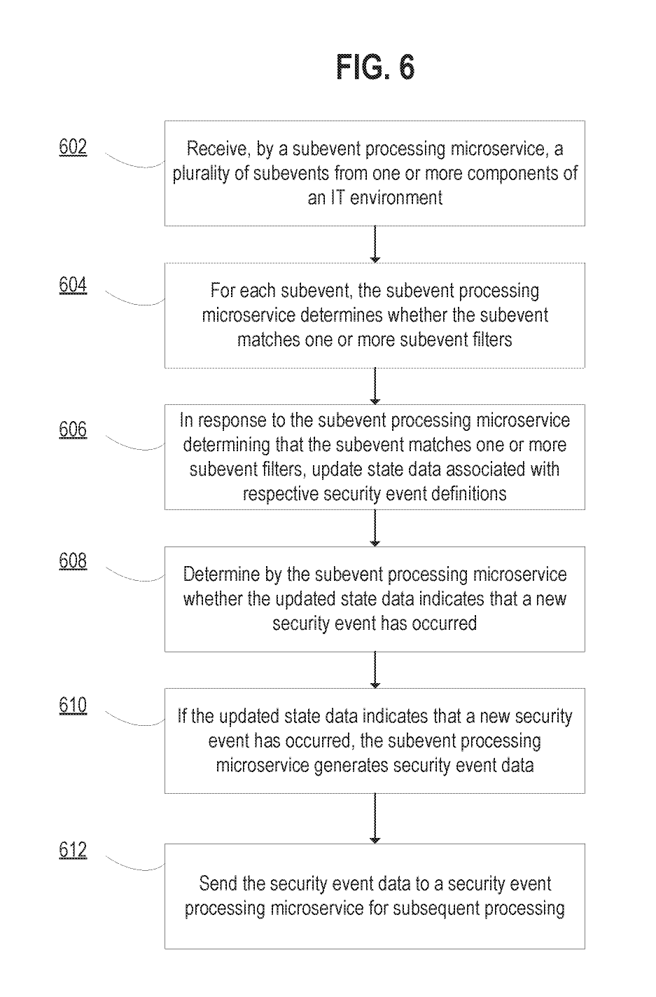

As depicted in FIG. 5, a security event state entry 502 may further include security event data 540, a security event timestamp 542, and a security event current state 544. In an embodiment, each time a subevent matches the subevent filter associated with a particular security event, a security event current state 544 is recomputed using a next-state table (e.g. a security event next-state table 418) or other state machine representation. When the security event current state 544 indicates that all of the conditions of the associated security event have been met, security event data and timestamp information may be generated for the detected occurrence of the security event. An example process for detecting occurrences of security events based on tracking state data associated with occurrences of subevents is described hereinafter in reference to the flow diagram of FIG. 6.

In one embodiment, a system administrator or other user may create one or more security event definitions used by a security service (e.g., corresponding to the security event data entries 410-420). For example, one or more configuration interfaces generated by a security service 306 may enable users to define and/or modify security event definitions, including modifying subevent filters, security event state criteria, etc. In other examples, one or more security event definitions may be pre-configured for users of a security service. Such event definitions may be periodically applied to a security system through updates via a subscription service or applied by an administrator.

In one embodiment, security service 306 monitors the generation of security events to determine whether a specific event definition might benefit from modification. Examples of this determination include counting a number of security events generated per unit time, counting a number of security events dismissed by an administrator, or based on any other quantitative or qualitative metric. As a result of such determination, security service 306 may disable an event definition, modify the subevent filter, modify the event state criteria, generate a user alert, or otherwise affect the generation of security events based on the specific event definition. Such modification may be made automatically, or by an administrator using a graphical user interface or other means in response to an alert.

FIG. 6 is a flow diagram illustrating an example process for filtering subevents generated by components of a computing environment, and translating the subevent activity into occurrences of security events.

At block 602, a plurality of subevents are received from one or more components of a computing environment. For example, a subevent processing microservice 340 may obtain the subevents from one or more of application(s) 302, server(s) 304, and/or microservices 310-332. Examples of subevents include, but are limited to, sending or receiving network messages, hardware or software component status messages, error messages, etc.

In an embodiment, a subevent processing microservice 340 may receive a subevent based on detecting an occurrence of the corresponding action, or based on obtaining data describing the corresponding action. For example, a subevent processing microservice 340 may receive one or more subevents based on receiving, intercepting, and/or otherwise detecting network messages, system messages, application messages, etc., where the subevents may be sent, received, or otherwise generated by any component of an associated computing environment. As another example, a subevent processing microservice 340 may receive one or more subevents based on receiving “pushed” event notifications from various system components, and/or a subevent processing microservice 340 may “pull” event data corresponding to subevents from one or more data sources (e.g., databases, log files, etc.).

At block 604, for each subevent received at block 602, it is determined whether the subevent matches one or more subevent filters. As described in reference to FIG. 3, a subevent processing microservice 340 may include one or more security event definitions, where each security event definition specifies one or more subevent filters. Each subevent filter may include one or more defined criteria that determine whether a particular subevent “matches” the filter and is therefore relevant to the security event definition.

In an embodiment, determining whether a subevent matches a subevent filter comprises determining whether one or more properties associated with the subevent satisfy the subevent filter criteria. As one example, a subevent filter may determine whether subevents match the filter based determining whether each subevent is a particular type of network message, has an IP address falling within a specified range of addresses, and is sent during a particular time of day. As another example, a subevent filter may determine whether subevents match the filter based on determining whether the subevent is a particular type of system event, and the event is generated by a particular type and version of application and/or operating system, etc. The information about each subevent used for the filter matching may be determined based on examining one of data fields associated with the subevent (e.g., one or more fields of a network packet, system message, etc.), based on data derived from the subevent (e.g., determining a time the subevent was generated, a size of the subevent, a duration of time between receiving the subevent and a previous subevent, etc.), or based on any other source of information.

At block 606, in response to determining that a subevent matches one or more subevent filters, state data associated with respective security event definitions is updated. For example, a subevent processing microservice 340 may update one or more subevent counters, subevent data fields, timestamp fields, security event state data, etc. As described above in reference to FIGS. 4-5, updating the state data may include incrementing/decrementing one or more counters, storing one or more timestamps or other data included with or derived from the associated subevent, determining a next state from a state table based on the subevent matching an associated filter, etc.

At block 608, it is determined whether the updated state data indicates that a new security event has occurred. For example, a security event state processor 342 of a subevent processing microservice 340 may determine whether a new security event has occurred based on updating state information associated with the security event, and detecting whether the next state information indicates that a security event has occurred. In other examples, a subevent processing microservice 340 may determine that a security event has occurred based on determining whether one or more associated subevent data values exceed or fall below some defined threshold, or based on any other criteria associated with the state data maintained for the security event definition. As one example, a particular security event definition may indicate that a particular security event has occurred when at least a specified number of a particular type of network message has been received by any one internal server within a specified period of time. Based on determining that one or more counters, timestamp values, and stored IP address values, a security event state processor 342 may determine when a sufficient number of network messages are received to indicate that the associated security event has occurred.

At block 610, in response to determining that the updated state data indicates that a new security event has occurred, security event data is generated. For example, a subevent processing microservice 340 may generate a message, notification, log entry, or any other type of data to indicate that the security event has occurred. The security event data may include data from one or more of the subevents that triggered the security event, based on one or more of the security event state items stored in association with the corresponding security event definition, or based on any other source of information related to the comprising subevents. For example, if a subevent processing microservice 340 detects an occurrence of a brute-force password attack security event, the microservice may generate security event state data indicating the type of security event, one or more source and/or destination IP addresses associated with the event, a time at which the attack started or ended, etc.

At block 612, the security event data is sent for subsequent processing. For example, a subevent processing microservice 340 may send the security event data generated at block 610 to a security event processing microservice 350. A security event processing microservice 350 may perform one or more actions depending on a type of the security event and based on information included in the associated security event data. For example, in response to receiving data indicating an occurrence of a security event, a security event processing microservice 350 may create one or more log entries, add or modify one or more network security rules, quarantine one or more associated computing devices, cause one or more security scans to be performed at one or more computing devices, etc.

The process described in relation to FIG. 6 illustrates a process whereby security events can be detected in real-time by continually updating state data as subevents are received, and by triggering the generation of security event data directly in response to receiving a pattern of subevents matching a security event definition. In this manner, occurrences of security events in a broader context can be detected and further processed without creating log or database entries for each subevent detected by the security application. However, in other examples, in addition to the real-time processing described in FIG. 6, a security application as described herein may also cause data for each subevent may to be stored in one or more logs, databases, or other storage. The logging of the subevent data may be used for instances in which the set of security definitions fails to detect one or more security events (e.g., because a security event is a new type of event that does not match any existing security event definition). In these and other similar instances, the logging of the subevent data in parallel may be used as a “backup” for the real-time processing of subevent data described in reference to FIG. 6.

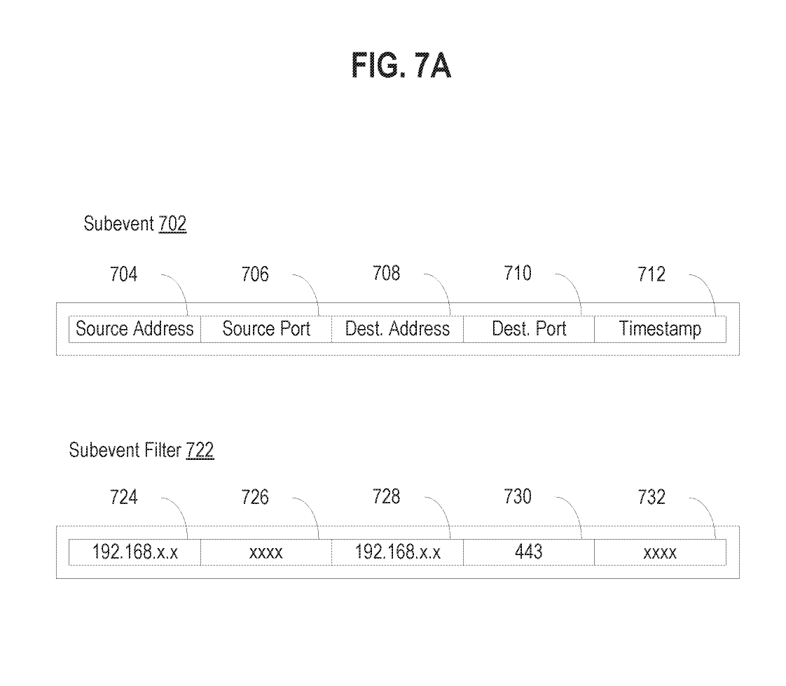

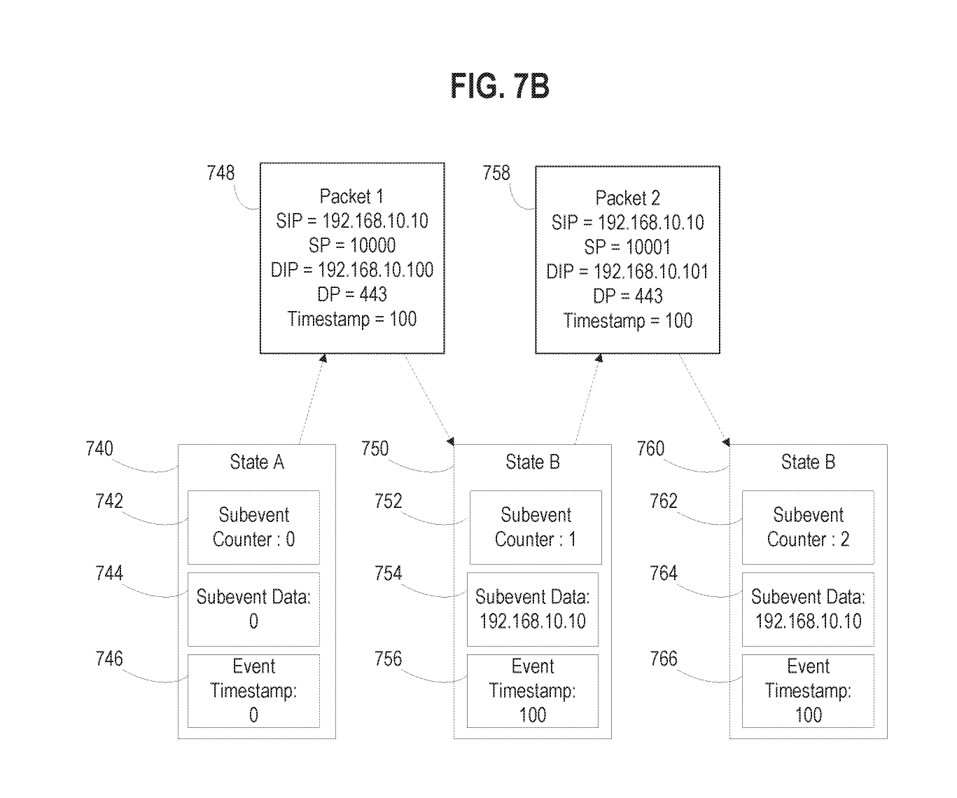

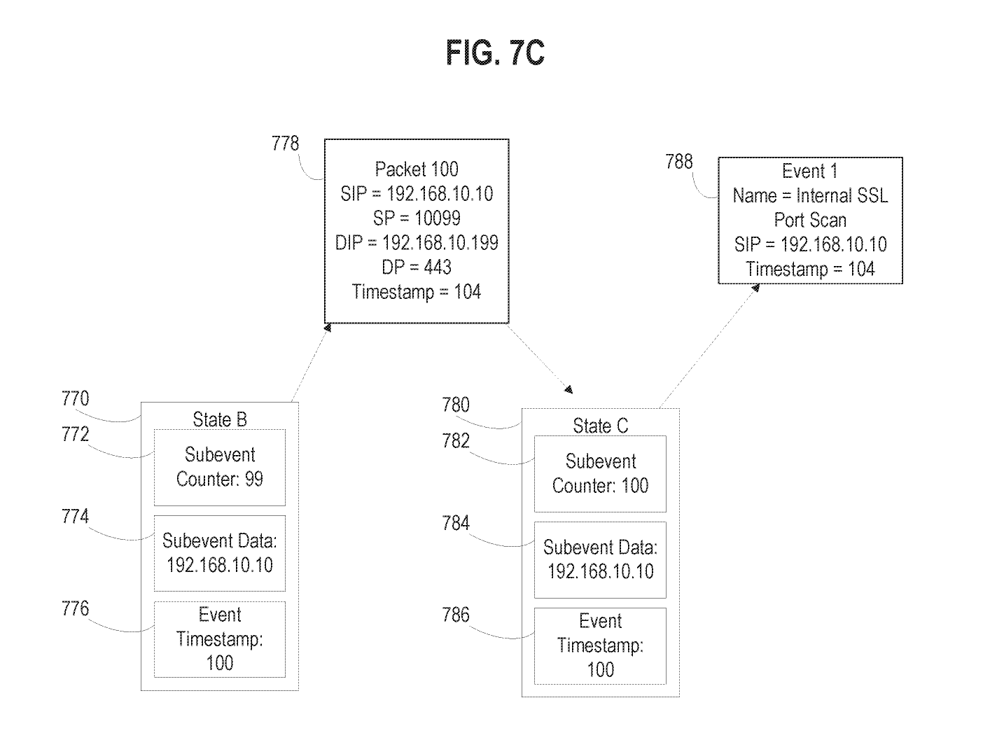

FIGS. 7A-7C illustrate an example of processing a plurality of subevents to detect an occurrence of a particular type of security event. In particular, the example elements depicted in FIGS. 7A-7C illustrate detecting a security event corresponding to a malware infection. In this example, a particular type of malware infection manifests itself when an internal computer is infected by the malware, and subsequently the same computer attempts a number of a SSL connections on specific ports with other machines within the same network. Consequently, a security event definition for detecting occurrences of the malware infection may specify that at least a certain number of network messages occur inside of the network (e.g., determined by the source and the destination addresses having a same subnet), and further specify that the network messages occur within a defined span of time. In the example of FIGS. 7A-7C, the security event definition specifies that a malware security event occurs when at least 100 network messages occur within a span of 5 seconds.

FIG. 7A depicts a subevent 702, illustrating the structure of an example subevent received by a subevent processing microservice 340. In this case, the subevent 702 is a network message comprising several data fields, including a source address 704 (e.g., an IP address), a source port 706, a destination address 708, a destination port 710, and a timestamp 712. The timestamp may be included in each network packet, or derived from the network packet (e.g., determined based on a time the network packet was sent or received). In an embodiment, a subevent 702 may be a network packet itself, or it may be a separate data structure comprising data derived from a network packet (e.g., generated by a different microservice running with the security application).

FIG. 7A further depicts an example of a subevent filter 722. For example, the subevent filter 722 may be specified as part of one or more security event definitions used by a security application to detect occurrences of the type of malware activity described above. The subevent filter 722 includes a source address filter 724 (e.g., specifying a network mask indicating a range of IP address of interest), a source port filter 726, a destination IP filter 628, a destination port filter 730, and a timestamp filter 732. As indicated above, occurrences of the malware security event of interest involve attempted SSL connections sent from one device in the local network to another local device. Thus, both of the source address filter 724 and destination address filters 728 match only local IP addresses, the destination port matches port 443 for the SSL service, and the remaining filters are expressed as wildcard values. Based on the filter, only received subevents which correspond to network messages sent from one internal device to another internal device and attempting a SSL connection are determined to be relevant to the malware security event definition.

In FIG. 7B, security event states 740-760 are used to illustrate a series of state transitions (e.g., indicated by the dashed arrows) based on receiving subevents corresponding to the network messages 748, 758 matching the subevent filter 722 depicted in FIG. 7A. For example, each of security event states 740-760 may correspond to one of a plurality of states of a state table stored in association with the security event definition for the malware security event. In this example, state A 740 is an initial default state at which zero matching subevents are recorded. Thus, state data associated with the state A 740 indicates a subevent counter 742 value of “0”, a subevent data 744 value of “0”, and a subevent timestamp value of “0.”

While the security event definition is in state A 740, a network message 748 is received. Because the network message 748 matches the subevent filter 722 (e.g., because it has a source address, destination address, and destination port matching the filter), the security event definition advances to state B 750. The state B 750 is a second state at which at least one subevent matching the filter has been received, but the set of subevents so far received does not yet satisfy all of the security event criteria (in particular, less than 100 matching network messages have been received within 5 seconds). As shown, the state B 750 indicates that security event state data associated with the security event definition is updated, including incrementing a subevent counter 752 value to “1” (e.g., indicating that 1 matching subevent has been received so far within a 5 second period), a subevent data 754 is assigned a value of “192.168.10.10.” (e.g., indicating an IP address associated with the device from which the matching subevent was received), and an event timestamp 756 is assigned a value of “100” (e.g., indicating a time at which the first matching subevent was received).

While the security event definition is in state B 750, a second network message 758 is received. Because the network message 758 also matches the subevent filter 722, but because the set of subevents so far received still does not yet satisfy all of the security event criteria, the security event definition remains in state B 760. The subevent counter 762 is incremented to 2 because the network message 758 was received within the defined period of time.

FIG. 7C illustrates additional state transition based on receiving a subevent satisfying a security event definition. In FIG. 7C, the security event definition initially is still in state B 770, with a subevent counter 772 indicating that 99 network messages matching the filter have so far been received within the defined period of time. While in state B 770, another network message 778 is received matching the security event filter. Based on updating the associated security event state data, including a subevent counter 782 indicating that 100 network messages have been received in the defined time period, a subevent processing microservice determines that a malware security event has occurred. In response to detecting the occurrence of the malware security event, the subevent processing microservice creates security event data 788. In FIG. 7C, the security event data 788 includes data indicating a name (e.g., “Internal SSL port scan” indicating that the event corresponds to an internal SSL port scan), a source IP address (e.g., derived from the source IP address contained in the corresponding subevents), and a timestamp (e.g., corresponding to the timestamp of the first, last, or average subevent).

The process described above with respect to FIGS. 7A-7C can be repeated any number of times, with the microservice remaining in state B 750 until the microservice reaches a point within state B 770, where the subevent counter increments from 99 to 100 based on receiving enough network messages within the specified period of time. If the defined time period elapses before enough network messages are received, the subevent processing microservice may remain in state B until a matching security is detected.

### 4.0. Example Embodiments

Examples of some embodiments are represented, without limitation, by the following:

In an embodiment, a method or non-transitory computer readable medium comprises: receiving a plurality of subevents, each subevent representing an occurrence of an action related to one or more components of an information technology (IT) environment; for each subevent of the plurality of subevents: determining whether the subevent matches one or more subevent filters of a plurality of subevent filters, each subevent filter associated with a security event definition of a plurality of security event definitions; in response to determining that the subevent matches one or more subevent filters, updating state data associated with one or more respective security event definitions; determining whether the updated state data indicates that a new security event has occurred; in response to determining that a new security event has occurred, generating security event data for subsequent processing.

In an embodiment, a method or non-transitory computer readable medium comprises: wherein at least one subevent of the plurality of subevents comprises a network packet.

In an embodiment, a method or non-transitory computer readable medium comprises: wherein at least one subevent of the plurality of subevents comprises a network packet specifying a source Internet Protocol (IP) address, a source port, a destination IP address, a destination port, and a timestamp.

In an embodiment, a method or non-transitory computer readable medium comprises: wherein at least one subevent of the plurality of subevents is one of an Internet Control Message Protocol (ICMP) network packet, a Transmission Control Protocol (TCP) packet, a Hypertext Transfer Protocol (HTTP) message, a Secure Shell (SSH) message, a Secure Sockets Layer (SSL) message.

In an embodiment, a method or non-transitory computer readable medium comprises: wherein at least one component of the one or more components of the computing environment includes one or more of a database server, a web server, an application server.

In an embodiment, a method or non-transitory computer readable medium comprises: wherein determining whether the subevent matches one or more of the subevent filters of the plurality of subevent filters includes determining whether the subevent comprises a particular type of network packet.

In an embodiment, a method or non-transitory computer readable medium comprises: wherein determining whether the subevent matches one or more of the subevent filters of the plurality of subevent filters includes determining whether the subevent is associated with a defined range of IP addresses.

In an embodiment, a method or non-transitory computer readable medium comprises: wherein the subevent is not stored in a log file.

In an embodiment, a method or non-transitory computer readable medium comprises: wherein determining whether the subevent matches the one or more subevent filters of the plurality of subevent filters occurs before the subevent is stored in a log file.

In an embodiment, a method or non-transitory computer readable medium comprises: wherein a security event definition defines a set of criteria for an occurrence of a security event corresponding to the security event definition.

In an embodiment, a method or non-transitory computer readable medium comprises: wherein each security event definition of the plurality of security event definitions comprises security event state data, wherein the security event state data comprises one or more of a subevent counter, a subevent timestamp, a subevent data field.

In an embodiment, a method or non-transitory computer readable medium comprises: wherein each security event definition of the plurality of security event definitions comprises one or more subevent filters.

In an embodiment, a method or non-transitory computer readable medium comprises: wherein updating the state data associated with the one or more respective security event definitions includes determining, based on the subevent, a next state of a plurality of event definition states.

In an embodiment, a method or non-transitory computer readable medium comprises: wherein generating the security event data for subsequent processing includes generating the security event data based on data derived from one or more subevents of the plurality of subevents.

In an embodiment, a method or non-transitory computer readable medium comprises: wherein the new security event represents one or more of a port scan, a denial-of-service (DoS) attack, a malware attack.

In an embodiment, a method or non-transitory computer readable medium comprises: wherein the subsequent processing includes performing one or more network security measures.

Other examples of these and other embodiments are found throughout this disclosure.

### 5.0. Implementation Mechanism—Hardware Overview

According to one embodiment, the techniques described herein are implemented by one or more special-purpose computing devices. The special-purpose computing devices may be desktop computer systems, portable computer systems, handheld devices, networking devices or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

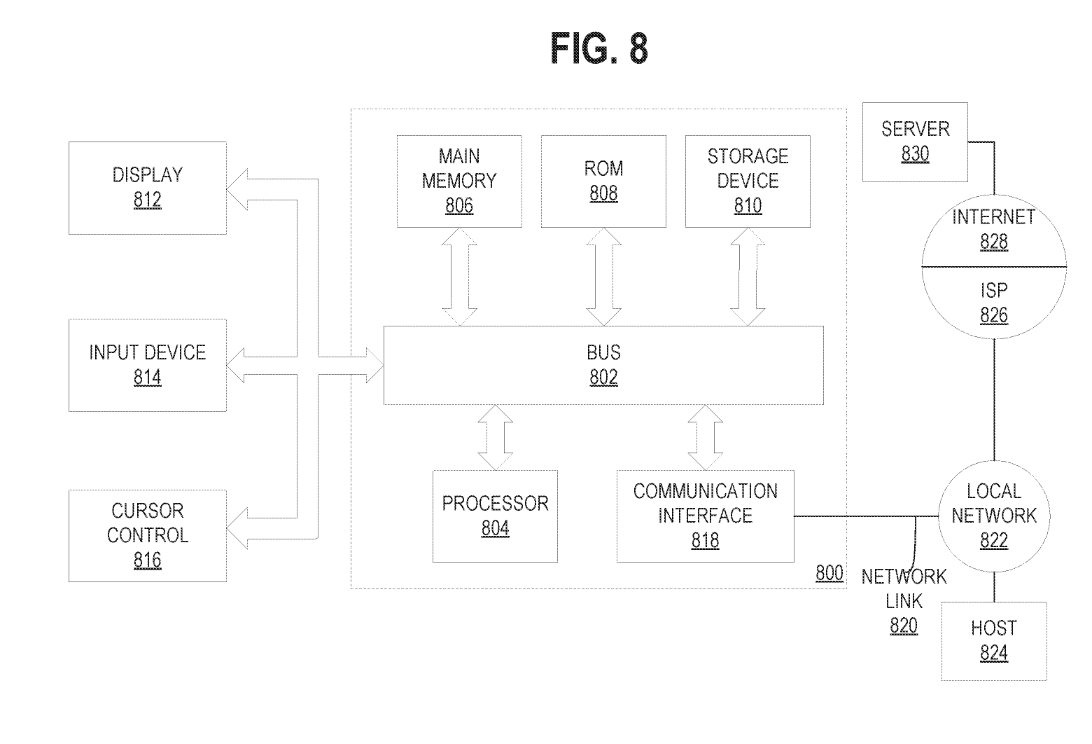

FIG. 8 is a block diagram that illustrates a computer system 800 utilized in implementing the above-described techniques, according to an embodiment. Computer system 800 may be, for example, a desktop computing device, laptop computing device, tablet, smartphone, server appliance, computing mainframe, multimedia device, handheld device, networking apparatus, or any other suitable device.

Computer system 800 includes one or more buses 802 or other communication mechanism for communicating information, and one or more hardware processors 804 coupled with buses 802 for processing information. Hardware processors 804 may be, for example, general purpose microprocessors. Buses 802 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 800 also includes a main memory 806, such as a random access memory (RAM) or other dynamic or volatile storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 a special-purpose machine that is customized to perform the operations specified in the instructions.

Computer system 800 further includes one or more read only memories (ROM) 808 or other static storage devices coupled to bus 802 for storing static information and instructions for processor 804. One or more storage devices 810, such as a solid-state drive (SSD), magnetic disk, optical disk, or other suitable non-volatile storage device, is provided and coupled to bus 802 for storing information and instructions.

Computer system 800 may be coupled via bus 802 to one or more displays 812 for presenting information to a computer user. For instance, computer system 800 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 812 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 812.

One or more input devices 814 are coupled to bus 802 for communicating information and command selections to processor 804. One example of an input device 814 is a keyboard, including alphanumeric and other keys. Another type of user input device 814 is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane. Yet other examples of suitable input devices 814 include a touch-screen panel affixed to a display 812, cameras, microphones, accelerometers, motion detectors, and/or other sensors. In an embodiment, a network-based input device 814 may be utilized. In such an embodiment, user input and/or other information or commands may be relayed via routers and/or switches on a Local Area Network (LAN) or other suitable shared network, or via a peer-to-peer network, from the input device 814 to a network link 820 on the computer system 800.

A computer system 800 may implement techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or a solid state drive of a remote computer. The remote computer can load the instructions into its dynamic memory and use a modem to send the instructions over a network, such as a cable network or cellular network, as modulate signals. A modem local to computer system 800 can receive the data on the network and demodulate the signal to decode the transmitted instructions. Appropriate circuitry can then place the data on bus 802. Bus 802 carries the data to main memory 806, from which processor 804 retrieves and executes the instructions. The instructions received by main memory 806 may optionally be stored on storage device 810 either before or after execution by processor 804.

A computer system 800 may also include, in an embodiment, one or more communication interfaces 818 coupled to bus 802. A communication interface 818 provides a data communication coupling, typically two-way, to a network link 820 that is connected to a local network 822. For example, a communication interface 818 may be an integrated services digital network (ISDN) card, cable modem, satellite modem, or a modem to provide a data communication connection to a corresponding type of telephone line. As another example, the one or more communication interfaces 818 may include a local area network (LAN) card to provide a data communication connection to a compatible LAN. As yet another example, the one or more communication interfaces 818 may include a wireless network interface controller, such as a 802.11-based controller, Bluetooth controller, Long Term Evolution (LTE) modem, and/or other types of wireless interfaces. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by a Service Provider 826. Service Provider 826, which may for example be an Internet Service Provider (ISP), in turn provides data communication services through a wide area network, such as the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

In an embodiment, computer system 800 can send messages and receive data, including program code and/or other types of instructions, through the network(s), network link 820, and communication interface 818. In the Internet example, a server X30 might transmit a requested code for an application program through Internet 828, ISP 826, local network 822 and communication interface 818. The received code may be executed by processor 804 as it is received, and/or stored in storage device 810, or other non-volatile storage for later execution. As another example, information received via a network link 820 may be interpreted and/or processed by a software component of the computer system 800, such as a web browser, application, or server, which in turn issues instructions based thereon to a processor 804, possibly via an operating system and/or other intermediate layers of software components.

In an embodiment, some or all of the systems described herein may be or comprise server computer systems, including one or more computer systems 800 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method, comprising:
receiving a plurality of subevents, each subevent representing an occurrence of an action related to one or more components of a computing environment;
for each subevent of the plurality of subevents:
determining whether the subevent matches one or more subevent filters of a plurality of subevent filters, each subevent filter associated with a security event definition of a plurality of security event definitions;
in response to determining that the subevent matches one or more subevent filters, updating state data associated with one or more respective security event definitions;
determining whether the updated state data indicates that a new security event has occurred;
in response to determining that a new security event has occurred, generating security event data for subsequent processing.

2. The method of claim 1, wherein at least one subevent of the plurality of subevents comprises a network packet.

3. The method of claim 1, wherein at least one subevent of the plurality of subevents comprises a network packet specifying a source Internet Protocol (IP) address, a source port, a destination IP address, a destination port, and a timestamp.

4. The method of claim 1, wherein at least one subevent of the plurality of subevents is one of a Transmission Control Protocol (TCP) packet, an Internet Control Message Protocol (ICMP) network packet, a Hypertext Transfer Protocol (HTTP) message, a Secure Shell (SSH) message, a Secure Sockets Layer (SSL) message.

5. The method of claim 1, wherein at least one component of the one or more components of the computing environment includes one or more of a database server, a web server, an application server.

6. The method of claim 1, wherein determining whether the subevent matches one or more of the subevent filters of the plurality of subevent filters includes determining whether the subevent comprises a particular type of network packet.

7. The method of claim 1, wherein determining whether the subevent matches one or more of the subevent filters of the plurality of subevent filters includes determining whether the subevent is associated with a defined range of IP addresses.

8. The method of claim 1, wherein the subevent is not stored in a log file.

9. The method of claim 1, wherein determining whether the subevent matches the one or more subevent filters of the plurality of subevent filters occurs before the subevent is stored in a log file.

10. The method of claim 1, wherein a security event definition defines a set of criteria for an occurrence of a security event corresponding to the security event definition.

11. The method of claim 1, wherein each security event definition of the plurality of security event definitions comprises security event state data, wherein the security event state data comprises one or more of a subevent counter, a subevent timestamp, a subevent data field.

12. The method of claim 1, wherein each security event definition of the plurality of security event definitions comprises one or more subevent filters.

13. The method of claim 1, wherein updating the state data associated with the one or more respective security event definitions includes determining, based on the subevent, a next state of a plurality of event definition states.

14. The method of claim 1, wherein generating the security event data for subsequent processing includes generating the security event data based on data derived from one or more subevents of the plurality of subevents.

15. The method of claim 1, wherein the new security event represents one or more of a port scan, a denial-of-service (DoS) attack, a malware attack.

16. The method of claim 1, wherein the subsequent processing includes performing one or more network security measures.

17. A non-transitory computer-readable storage medium storing instructions which, when executed by one or more processors, cause performance of operations comprising:
receiving a plurality of subevents, each subevent representing an occurrence of an action related to one or more components of a computing environment;
for each subevent of the plurality of subevents:
determining whether the subevent matches one or more subevent filters of a plurality of subevent filters, each subevent filter associated with a security event definition of a plurality of security event definitions;
in response to determining that the subevent matches one or more subevent filters, updating state data associated with one or more respective security event definitions;
determining whether the updated state data indicates that a new security event has occurred;
in response to determining that a new security event has occurred, generating security event data for subsequent processing.

18. The non-transitory computer-readable storage medium of claim 17, wherein at least one subevent of the plurality of subevents comprises a network packet.

19. The non-transitory computer-readable storage medium of claim 17, wherein at least one component of the one or more components of the computing environment includes one or more of a database server, a web server, an application server.

20. The non-transitory computer-readable storage medium of claim 17, wherein the subevent is not stored in a log file.

21. The non-transitory computer-readable storage medium of claim 17, wherein a security event definition defines a set of criteria for an occurrence of a security event corresponding to the security event definition.

22. The method of claim 1, wherein generating the security event data for subsequent processing includes generating the security event data based on data derived from one or more subevents of the plurality of subevents.

23. The method of claim 1, wherein the subsequent processing includes performing one or more network security measures.

24. An apparatus, comprising:
one or more processors;
a non-transitory computer-readable storage medium coupled to the one or more processors, the computer-readable storage medium storing instructions which, when executed by the one or more processors, causes the apparatus to:
receive a plurality of subevents, each subevent representing an occurrence of an action related to one or more components of a computing environment;
for each subevent of the plurality of subevents:
determine whether the subevent matches one or more subevent filters of a plurality of subevent filters, each subevent filter associated with a security event definition of a plurality of security event definitions;
in response to determining that the subevent matches one or more subevent filters, update state data associated with one or more respective security event definitions;
determine whether the updated state data indicates that a new security event has occurred;
in response to determining that a new security event has occurred, generate security event data for subsequent processing.

25. The apparatus of claim 24, wherein at least one subevent of the plurality of subevents comprises a network packet.

26. The apparatus of claim 24, wherein at least one component of the one or more components of the computing environment includes one or more of a database server, a web server, an application server.

27. The apparatus of claim 24, wherein the subevent is not stored in a log file.

28. The apparatus of claim 24, wherein a security event definition defines a set of criteria for an occurrence of a security event corresponding to the security event definition.

29. The apparatus of claim 24, wherein generating the security event data for subsequent processing includes generating the security event data based on data derived from one or more subevents of the plurality of subevents.

30. The apparatus of claim 24, wherein the subsequent processing includes performing one or more network security measures.
